(19) United States
(12) Patent Application Publication
(10) Pub. No.: US 2017/0038824 A1
(43) Pub. Date: Feb. 9, 2017

(54) METHOD AND APPARATUS FOR REDUCING CONSUMPTION OF STANDBY POWER THROUGH DETECTION OF IDLE STATE OF SYSTEM

(71) Applicant: Electronics and Telecommunications Research Institute, Daejeon (KR)

(72) Inventors: Baik-Song AN, Seoul (KR); Sung-Ik JUN, Daejeon (KR)

(21) Appl. No.: 15/179,407

(22) Filed: Jun. 10, 2016

(30) Foreign Application Priority Data
Aug. 4, 2015 (KR) 10-2015-0110162

(51) Int. Cl. G06F 1/32; G06F 1/28; G06F 9/44

(52) U.S. Cl. CPC G06F 1/3296; G06F 9/4418; G06F 1/28

(57) ABSTRACT

A method and apparatus for reducing the consumption of standby power through the detection of the idle state of a system are disclosed herein. The apparatus includes a task information acquisition unit, an idle state detection unit, a power reduction determination unit, and a power reduction performance unit. The task information acquisition unit acquires task information from a scheduler. The idle state detection unit detects whether at least one apparatus enters an idle state based on the task information. The power reduction determination unit determines whether to perform the reduction of power consumption of the at least one apparatus based on at least one of an idle counter and the time elapsed after occurrence. The power reduction performance unit performs low-power mode using an apparatus manager corresponding to the at least one apparatus if it is determined that the reduction of power consumption is to be performed.

### CROSS-REFERENCE TO RELATED APPLICATION

This application claims the benefit of Korean Patent Application No. 10-2015-0110162, filed Aug. 4, 2015, which is hereby incorporated by reference herein in its entirety.

### BACKGROUND

1. Technical Field

The present disclosure relates generally to technology for reducing the consumption of standby power of an information technology (IT) device, such as a desktop computer, a server or a mobile device, and more particularly to technology for reducing the consumption of standby power, which can detect entry into an idle state, can analyze a pattern, and can improve the effect of reducing the consumption of standby power.

2. Description of the Related Art

Recently, due to a rapid increase in the number of mobile devices having the issue of battery usage time as well as environmental and energy problems, interest in the reduction of power consumption has been extended to the fields of servers and personal computers (PCs). Furthermore, with the rapid popularization of smart equipment and start apparatuses, the number of IT apparatuses and terminals on which operating systems run increases rapidly, and thus interest in OS-related technology capable of reducing energy consumption is also increasing rapidly.

Processors mounted in recently-developed IT devices, such as a desktop computer, a server, a mobile device, etc., support a low-power idle state in order to reduce power and energy consumption in a idle system state. This is represented and managed using the C-state of a processor. The C-state is defined according to the ACPI standards. In order to increase the effect of reducing the consumption of standby power, a vendor-specific C-state is additionally defined and managed. Using these C-states, the stepwise management of an idle state can be performed in accordance with the system situation of an IT device.

Although a C-state at the highest step is prompted to be entered in order to minimize the standby power of a system, load latency that is proportional to the level of the step of C-state occurs upon entry into an idle state and return to an active state. Accordingly, it is very important to search for a C-state step appropriate for system idle time while taking into account a load based on entry and return. For example, when a C-state step requiring 2 ms for each of entry and return is entered in the case in which system idle time is merely 3 ms, a time load required to perform the reduction of power consumption is longer than idle time, and thus wastes may be caused in terms of the amount of power consumption and performance.

Furthermore, there are many cases in which excessively frequent entry into C-state causes an adverse effect in terms of power consumption. For example, in a situation in which short idle time is repeated, there may occur a case in which additional time and an additional power load that occur upon entry into and return from the C-state step become greater than the load of a task to be processed. In the aforementioned case, it may be advantageous in terms of power consumption and performance to limit entry into a C-state step and maintain a system in an active state. There is a need for a management technique based on a method of allowing such entry into C-state at a high step only in a case in which sufficient idle time is guaranteed in a defensive manner.

The conventional technology has a problem in that the effect of reducing power consumption decreases as performance and a power consumption load increase due to excessively aggressive inducement to entry into the C-state. Aggressive inducement to entry into the C-state is a method that can be used on the assumption that the accuracy of prediction of idle time is very high. When actual idle time is shorter than predicted idle time, a considerable disadvantage must be accepted in terms of performance and power consumption.

Accordingly, in order to overcome the problems of the conventional technology, there is an urgent need for technology for reducing the consumption of standby power, which can prevent unnecessary entry into a C-state step while taking into account idle mode entry elapsed time and a system idle mode entry pattern, thereby minimizing disadvantages regarding power and performance and also improving the effect of reducing the consumption of standby power.

In connection with this, Korean Patent Application Publication No. 2013-0087583 published on Aug. 6, 2013 discloses a technology related to “Method, Apparatus and System for Switching System Power State of Computer Platform.”

### SUMMARY

At least one embodiment of the present invention is directed to the provision of a method of reducing the consumption of standby power that prevents unnecessary entry into low-power mode, thereby minimizing disadvantages regarding power and performance.

At least one embodiment of the present invention efficiently performs the reduction of the consumption of standby power based on elapsed time in an idle state, thereby improving the effect of reducing the consumption of standby power.

In accordance with an aspect of the present invention, there is provided an apparatus for reducing the consumption of standby power through the detection of the idle state of a system, including: a task information acquisition unit configured to acquire task information from a scheduler that manages the processing of one or more tasks; an idle state detection unit configured to detect whether at least one apparatus enters an idle state, in which there is no task to be processed, based on the task information; a power reduction determination unit configured to determine whether to perform the reduction of power consumption of the at least one apparatus based on at least one of an idle counter and the time elapsed after occurrence; and a power reduction performance unit configured to perform low-power mode for reducing the consumption of standby power of the at least one apparatus using an apparatus manager corresponding to the at least one apparatus if it is determined that the reduction of power consumption is to be performed.

The power reduction determination unit may determine that the reduction of power consumption is to be performed if at least one of a case in which the value of the idle counter exceeds a preset reference entry count and a case in which the time elapsed after occurrence exceeds preset reference elapsed time occurs.

The power reduction determination unit may determine whether to perform the reduction of power consumption if the at least one apparatus enters the idle state.

The power reduction determination unit may include: an idle counter management unit configured to, when a system corresponding to the at least one apparatus is activated, initialize the idle counter to a preset initial counter value, and increase the value of the idle counter based on at least one of a re-entry flag and the time elapsed after occurrence that are used to adjust the number of times the reduction of power consumption is performed; and a re-entry flag management unit configured to, when the system is activated, initialize the re-entry flag to a preset initial flag value, release the reduction of power consumption, and change the re-entry flag.

The apparatus may further include a power reduction release unit configured to, after the reduction of power consumption has been performed, detect the occurrence of an event corresponding to the at least one apparatus, and release the performance of the reduction of power consumption.

The power reduction determination unit may determine the preset reference entry count while taking into account a load that occurs when the at least one apparatus enters and returns from a C-state step corresponding to the low-power mode.

The power reduction performance unit may perform the low-power mode using a standby mode support means, supported by the hardware of the system, via the apparatus manager.

The power reduction release unit may detect the occurrence of an event including at least one of events registered as a non-maskable interrupt, a system management interrupt, an INIT event, a BINT event, an MCERR event, a fault interrupt, an abort interrupt, a machine check interrupt, TLB Invalidation, and SoftIRQ.

The time elapsed after occurrence may correspond to the elapsed time between a current idle state and a previous idle state.

In accordance with another aspect of the present invention, there is provided a method of reducing the consumption of standby power through the detection of the idle state of a system, including: acquiring task information from a scheduler that manages the processing of one or more tasks; detecting whether at least one apparatus enters an idle state, in which there is no task to be processed, based on the task information; determining whether to perform the reduction of power consumption of the at least one apparatus based on at least one of an idle counter and the time elapsed after occurrence; and performing low-power mode for reducing the consumption of standby power of the at least one apparatus using an apparatus manager corresponding to the at least one apparatus if it is determined that the reduction of power consumption is to be performed.

The determining may include determining that the reduction of power consumption is to be performed if at least one of a case in which the value of the idle counter exceeds a preset reference entry count and a case in which the time elapsed after occurrence exceeds preset reference elapsed time occurs.

The determining may include determining whether to perform the reduction of power consumption if the at least one apparatus enters the idle state.

The determining may include: initializing the idle counter to a preset initial counter value when a system corresponding to the at least one apparatus is activated; increasing the value of the idle counter based on at least one of a re-entry flag and the time elapsed after occurrence that are used to adjust the number of times the reduction of power consumption is performed; initializing the re-entry flag to a preset initial flag value when the system is activated; and releasing the reduction of power consumption, and then changing the re-entry flag.

The method may further include, after the reduction of power consumption has been performed, detecting the occurrence of an event corresponding to the at least one apparatus, and releasing the performance of the reduction of power consumption.

The determining may include determining the preset reference entry count while taking into account a load that occurs when the at least one apparatus enters and returns from a C-state step corresponding to the low-power mode.

The performing may include performing the low-power mode using a standby mode support means, supported by the hardware of the system, via the apparatus manager.

The releasing may include detecting the occurrence of an event including at least one of events registered as a non-maskable interrupt, a system management interrupt, an INIT event, a BINT event, an MCERR event, a fault interrupt, an abort interrupt, a machine check interrupt, TLB Invalidation, and SoftIRQ.

The time elapsed after occurrence may correspond to the elapsed time between a current idle state and a previous idle state.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing an apparatus for reducing the consumption of standby power through the detection of the idle state of a system according to an embodiment of the present invention, which is located inside an operating system;

FIG. 2 is a block diagram showing an example of the apparatus for reducing the consumption of standby power, which is shown in FIG. 1;

FIG. 3 is a block diagram showing an example of the power reduction determination unit shown in FIG. 2;

FIG. 4 is a diagram showing the structure of a target system to which the apparatus for reducing the consumption of standby power according to an embodiment of the present invention is applied;

FIG. 5 is a diagram showing the reduction of power consumption based on the level of the idle state of a processor;

FIG. 6 is an operation flowchart showing a method of reducing the consumption of standby power through the detection of the idle state of a system according to an embodiment of the present invention;

FIG. 7 is an operation flowchart showing a method of reducing the consumption of standby power through the detection of the idle state of a system according to an embodiment of the present invention in detail; and

FIG. 8 is an operation flowchart showing the step of determining whether to perform the reduction of power consumption, which is shown in FIG. 7, in detail.

### DETAILED DESCRIPTION

Embodiments of the present invention will be described in detail below with reference to the accompanying drawings. Redundant descriptions and descriptions of well-known functions and configurations that have been deemed to make the gist of the present invention unnecessarily obscure will be omitted below. The embodiments of the present invention are intended to fully describe the present invention to persons having ordinary knowledge in the art to which the present invention pertains. Accordingly, the shapes, sizes and the like of components in the drawings may be exaggerated to make the description obvious.

Embodiments of the present invention will be described in detail with reference to the accompanying drawings.

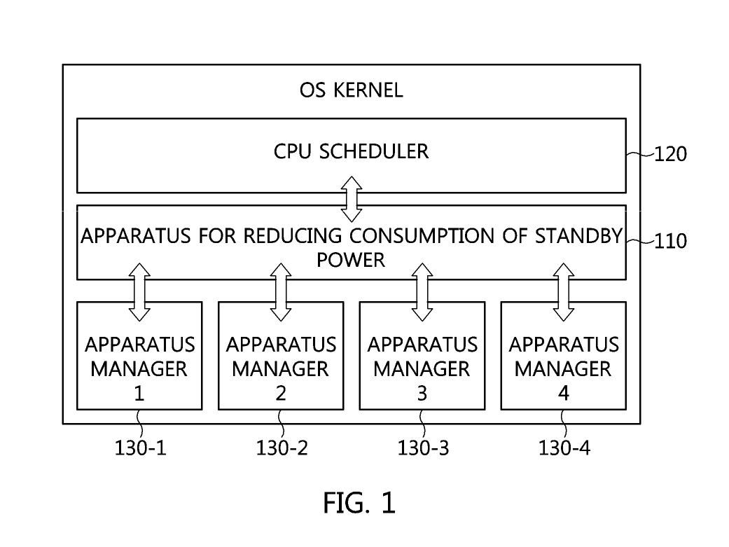

FIG. 1 is a diagram showing an apparatus 110 for reducing the consumption of standby power through the detection of the idle state of a system according to an embodiment of the present invention, which is located inside an operating system (OS).

Referring to FIG. 1, the apparatus 110 for reducing the consumption of standby power according to the present embodiment may be located inside an OS, and may operate in conjunction with other components.

The apparatus 110 for reducing the consumption of standby power may acquire task information from a CPU scheduler 120 that manages the processing of one or more tasks.

Furthermore, the apparatus 110 for reducing the consumption of standby power detects whether at least one apparatus enters an idle state, in which there is no task to be processed, based on the task information.

Furthermore, the apparatus 110 for reducing the consumption of standby power may determine whether to perform the reduction of power consumption of the at least one apparatus based on at least one of an idle counter and the time elapsed after occurrence.

In this case, if at least one of a case where the value of the idle counter exceeds a preset reference entry count and a case in which the time elapsed after occurrence exceeds preset reference elapsed time occurs, it is determined that the reduction of power consumption is to be performed.

In this case, when the at least one apparatus enters an idle state, whether to perform the reduction of power consumption is determined.

In this case, when a system corresponding to at least one apparatus is activated, the idle counter may be initialized to a preset initial counter value, and the value of the idle counter may be increased based on at least one of a re-entry flag and the time elapsed after occurrence that are used to adjust the number of times the reduction of power consumption is performed.

In this case, the system may initialize the re-entry flag, to be executed, to a preset initial flag value, may release the performance of the reduction of power consumption, and may change the re-entry flag.

In this case, it may be possible to determine the preset reference entry count while taking into account a load that occurs when at least one apparatus enters or returns from a C-state step corresponding to low-power mode.

In this case, the time elapsed after occurrence may correspond to the elapsed time between a current idle state and a previous idle state.

Furthermore, if it is determined that the reduction of power consumption is to be performed, the apparatus 110 for reducing the consumption of standby power may perform the low-power mode for reducing the consumption of standby power of the at least one apparatus using an apparatus manager 130-1, . . . , or 130-4 corresponding to the at least one apparatus.

In this case, the low-power mode may be performed using a standby mode support means, supported by the hardware of the system, via the apparatus manager 130-1, . . . , or 130-4.

Furthermore, the apparatus 110 for reducing the consumption of standby power may perform the reduction of power consumption, may detect the occurrence of an event corresponding to the at least one apparatus, and may release the performance of the reduction of power consumption.

In this case, the apparatus 110 for reducing the consumption of standby power may detect the occurrence of an event including at least one of events registered as a non-maskable interrupt, a system management interrupt, an INIT event, a BINT event, an MCERR event, a fault interrupt, an abort interrupt, a machine check interrupt, TLB Invalidation and SoftIRQ.

The idle state of a system refers to a state in which there is not task that is performed by the system or that will be processed. When the CPU scheduler 120 detects the idle state and notifies the apparatus 110 for reducing the consumption of standby power of the idle state, the apparatus 110 for reducing the consumption of standby power controls the apparatus managers 130-1 to 130-4 within an OS in order to prompt the at least one apparatus to enter low-power mode. That is, operation management in which a processor enters a C-state step may be performed via the apparatus managers 130-1 to 130-4.

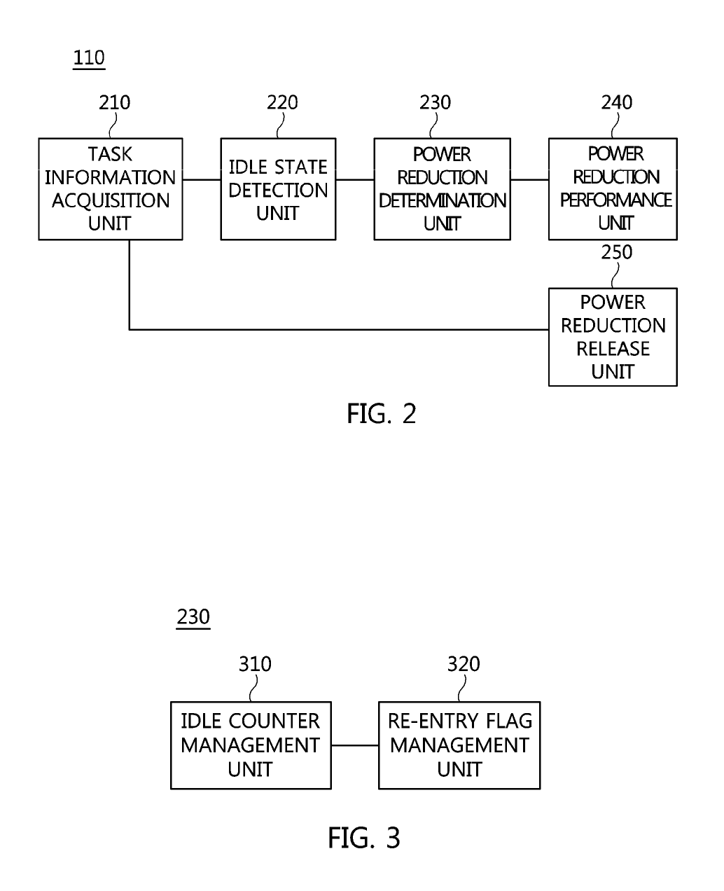

FIG. 2 is a block diagram showing an example of the apparatus 110 for reducing the consumption of standby power, which is shown in FIG. 1.

Referring to FIG. 2, the apparatus 110 for reducing the consumption of standby power, which is shown in FIG. 1, may include a task information acquisition unit 210, an idle state detection unit 220, a power reduction determination unit 230, a power reduction performance unit 240, and a power reduction release unit 250.

The task information acquisition unit 210 may acquire task information from a scheduler that manages the processing of one or more tasks. For example, the task information acquisition unit 210 may acquire a list of tasks that need to be currently performed or processed or information about whether a task to be processed remains via a CPU scheduler that manages one or more tasks of a CPU.

The idle state detection unit 220 may detect whether at least one apparatus enters an idle state, in which there is no task to be processed, based on the task information. For example, a case in which there is no task to be processed for at least one apparatus may be determined to be an idle state, a separate injector for entry into an idle state may be invoked, and then the idle state may be entered. In this case, the entry into the idle state may be detected by detecting whether the separate injector for entry into the idle state is invoked.

The power reduction determination unit 230 may determine whether to perform the reduction of power consumption of at least one apparatus based on at least one of an idle counter and the time elapsed after occurrence.

In this case, the reason for determining whether to perform the reduction of power consumption even when the idle state has been entered is that the size of a load that may occur when the reduction of power consumption is performed may be larger than the size of performance that can be saved due to the reduction of power consumption. Accordingly, in order to prevent a waste from occurring due to the performance of the reduction of power consumption, a case in which the reduction of power consumption can be efficiently performed may be determined using factors, such as an idle counter and the time elapsed after occurrence, and then the reduction of power consumption may be performed.

In this case, the value of the idle counter may be a counter value that is maintained in order to prevent an unnecessary load from occurring due to excessive entry into low-power mode when the number of times the idle state is entered is large.

In this case, the time elapsed after occurrence may correspond to the elapsed time between a current idle state and a previous idle state. For example, it may be possible to check a point in time whenever an idle state occurs and calculate the time elapsed after occurrence via the interval between the checked points in time.

Furthermore, after the idle state had been entered and then the time elapsed after occurrence has been calculated, a current point in time may be set as a previous point in time in order to prepare for a case in which a subsequent idle state occurs.

In this case, when at least one of a case in which the value of the idle counter exceeds the preset reference entry count and a case in which the time elapsed after occurrence exceeds the preset reference elapsed time occurs, it is determined that the reduction of power consumption is to be performed. For example, when at least one apparatus has entered the idle state, the reduction of power consumption is not performed and the gradually increasing value of the idle counter exceeds the preset reference entry count, the reduction of power consumption may be to be performed. Furthermore, when the preset reference entry count is not exceeded but the time elapsed after occurrence exceeds the preset reference elapsed time, the reduction of power consumption may be to be performed.

In this case, in order to determine whether to perform the reduction of power consumption, DeepIdleInjector used for the efficient idle management of the system may be invoked. An action for the actual performance of the reduction of power consumption is performed at DeepIdleInjector, and the apparatus 110 for reducing the consumption of standby power may be implemented in the form of a framework for supporting it. In the case of Linux, the apparatus 110 for reducing the consumption of standby power is designed as a framework called “cpuidle,” and the actual reduction of the consumption of standby power of a CPU is performed in conjunction with its lower-level module. DeepIdleInjector may correspond to the lower-level module.

In this case, when the at least one apparatus enters an idle state, whether to perform the reduction of power consumption is determined. That is, since the reduction of power consumption can be performed only in a state in which there is no task that is processed by the at least one apparatus, whether to perform the reduction of power consumption may be determined only when the idle state has been entered.

In this case, when a system corresponding to the at least one apparatus is activated, the idle counter may be initialized to the preset initial counter value, and the value of the idle counter may be increased based on at least one of a re-entry flag and the time elapsed after occurrence that are used to adjust the number of times the reduction of power consumption is performed. For example, the apparatus 110 for reducing the consumption of standby power may be initialized by invoking the initialization routine of the apparatus 110 for reducing the consumption of standby power from the inside of an OS initialization routine when an OS is booted. In this case, the idle counter and the re-entry flag may be initialized. Furthermore, an initialization invocation point in time may be stored by checking a current point in time and storing the current point in time as previous time point information, and then termination may be performed.

Furthermore, when the time elapsed after occurrence is equal to or shorter than the preset reference elapsed time and also the re-entry flag corresponds to 0, the value of the idle counter may be increased.

In this case, when the system is activated, the re-entry flag may be initialized to the preset initial flag value, the performance of the reduction of power consumption may be released, and then the re-entry flag may be changed.

In this case, the re-entry flag is used to prevent the apparatus 110 for reducing the consumption of standby power from inefficiently operating because the reduction of power consumption is actually frequently performed when DeepIdleInjector is currently frequently invoked. The re-entry flag may correspond to a flag value that is used to determine whether to perform low-power mode.

Furthermore, the re-entry flag may be initialized to a value corresponding to 1 in the initialization routine, and may be changed into a value corresponding to 0 after the reduction of power consumption has been performed.

Furthermore, the time elapsed after occurrence, i.e., the time elapsed from a previous idle state entry point in time (i.e., a previous DeepIdleInjector entry point in time) to a current point in time, may be calculated, and the re-entry flag may be initialized to a value corresponding to 1 if the time elapsed after occurrence is longer than the preset reference elapsed time.

In this case, the preset reference entry count may be determined based on a load that occurs when at least one apparatus enters or returns from the C-state step corresponding to the low-power mode. That is, the occurrence of an unnecessary load due to entry into an excessively low C-state step may be prevented by setting the preset reference entry count in proportion to a stepwise entry and return load of the C-state that is provided by a processor.

The power reduction performance unit 240 may perform low-power mode for reducing the consumption of standby power of the at least one apparatus using an apparatus manager corresponding to the at least one apparatus if it is determined that the reduction of power consumption is to be performed.

In this case, the power reduction performance unit 240 may perform low-power mode using a standby mode support means, supported by the hardware of the system, via the apparatus manager.

For example, the low-power mode may be performed by invoking a routine, such as IdleInjector. IdleInjector is a routine configured to prompt entry into actual low-power mode, and may use the standby mode support means, supported by the hardware, via the apparatus manager. In the case of an X86 system, stepwise C-state entry may be performed by invoking an MWAIT assembly instruction. In the case of an ARM system, entry into the low-power mode may be performed via a Wait For Interrupt (WFI) instruction. When there is no standby mode support means that supported by the hardware, a standby state may be maintained via an instruction, such as NOP/HLT.

Furthermore, at the initialization step of the apparatus 110 for reducing the consumption of standby power, a hardware-level standby mode support means may be automatically searched for, and may be registered and then used in IdleInjector. As an example, in the case of an X86 system, whether an MWAIT instruction is supported may be determined by inspecting a third bit value during the invocation of a CPUID instruction after an ECX register has been set to 1.

After the reduction of power consumption has been performed, the power reduction release unit 250 may detect the occurrence of an event corresponding to the at least one apparatus, and may release the performance of the reduction of power consumption.

In this case, the power reduction release unit 250 may detect the occurrence of an event including at least one of events registered as a non-maskable interrupt, a system management interrupt, an INIT event, a BINT event, an MCERR event, a fault interrupt, an abort interrupt, a machine check interrupt, TLB Invalidation, and SoftIRQ.

In this case, a process of searching for and registering a hardware-level standby mode support means is now described. A task in which after entry into the low-power mode, the system is woke up and returns to active mode may be triggered and performed upon the occurrence of a specific event. This event is various according to hardware and system, and may generally correspond to the occurrence of a non-maskable interrupt, the occurrence of a system management interrupt, the occurrence of an INIT event, a BINT event, the occurrence of an MCERR event, the occurrence of a fault interrupt, the occurrence of an abort interrupt, the occurrence of a machine check interrupt, the occurrence of TLB Invalidation, the occurrence of an event registered as SoftIRQ, etc.

FIG. 3 is a block diagram showing an example of the power reduction determination unit 230 shown in FIG. 2.

Referring to FIG. 3, the power reduction determination unit 230 shown in FIG. 2 may include an idle counter management unit 310 and a re-entry flag management unit 320.

When a system corresponding to at least one apparatus is activated, the idle counter management unit 310 may initialize the idle counter to the preset initial counter value, may increase the value of the idle counter based on at least one of the re-entry flag and the time elapsed after occurrence used to adjust the number of times the reduction of power consumption is performed.

For example, the apparatus 110 for reducing the consumption of standby power may be initialized by invoking the initialization routine of the apparatus 110 for reducing the consumption of standby power from the inside of an OS initialization routine when an OS is booted. In this case, the idle counter and the re-entry flag may be initialized. Furthermore, an initialization invocation point in time may be stored by checking a current point in time and storing the current point in time as previous time point information, and then termination may be performed.

Furthermore, when the time elapsed after occurrence is equal to or shorter than the preset reference elapsed time and also the re-entry flag corresponds to 0, the value of the idle counter may be increased.

When the system is activated, the re-entry flag management unit 320 may initialize the re-entry flag to the preset initial flag value, may release the performance of the reduction of power consumption may be released, and then may change the re-entry flag.

In this case, the re-entry flag is used to prevent the apparatus 110 for reducing the consumption of standby power from inefficiently operating because the reduction of power consumption is actually frequently performed when DeepIdleInjector is currently frequently invoked. The re-entry flag may correspond to a flag value that is used to determine whether to perform low-power mode.

Furthermore, the re-entry flag may be initialized to a value corresponding to 1 in the initialization routine, and may be changed into a value corresponding to 0 after the reduction of power consumption has been performed.

Furthermore, the time elapsed after occurrence, i.e., the time elapsed from a previous idle state entry point in time (i.e., a previous DeepIdleInjector entry point in time) to a current point in time, may be calculated, and the re-entry flag may be initialized to a value corresponding to 1 if the time elapsed after occurrence is longer than the preset reference elapsed time.

In this case, the preset reference entry count may be determined based on a load that occurs when at least one apparatus enters or returns from the C-state step corresponding to the low-power mode. That is, the occurrence of an unnecessary load due to entry into an excessively low C-state step may be prevented by setting the preset reference entry count in proportion to a stepwise entry and return load of the C-state that is provided by a processor.

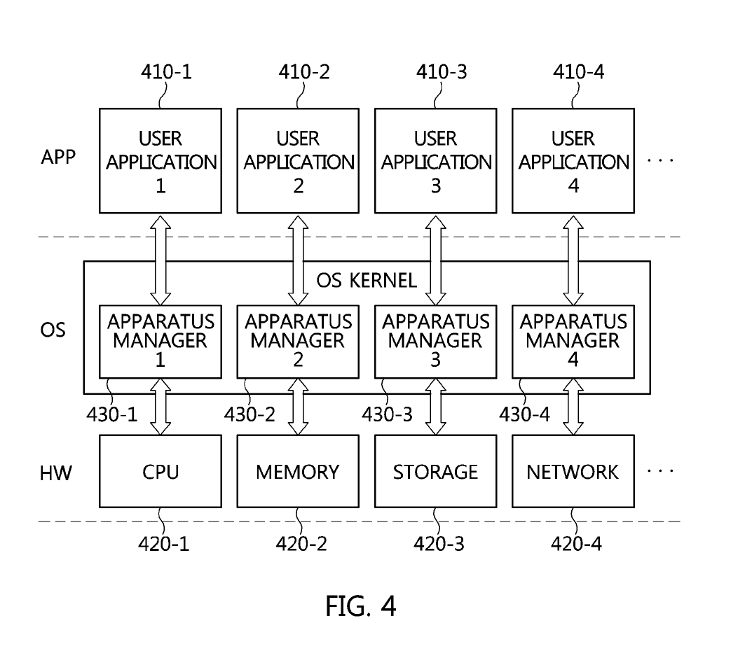

FIG. 4 is a diagram showing the structure of a target system to which the apparatus for reducing the consumption of standby power according to an embodiment of the present invention is applied.

Referring to FIG. 4, in the target system to which the apparatus for reducing the consumption of standby power according to an embodiment of the present invention is applied, an OS kernel may be present above hardware 420-1 to 420-4 including a CPU, memory, storage, and a network, and may manage system resources including the hardware 420-1 to 420-4 via apparatus managers 430-1 to 430-4.

In this case, the OS kernel may provide services to user application programs 410-1 to 410-4.

In this case, the user application programs 410-1 to 410-4 are based on a concept including a system-level library and middleware. The user application programs 410-1 to 410-4 may define and implement a series of functions for providing direct services to a user, and may communicate with a lower-level OS kernel via a system call and a previously defined system interface.

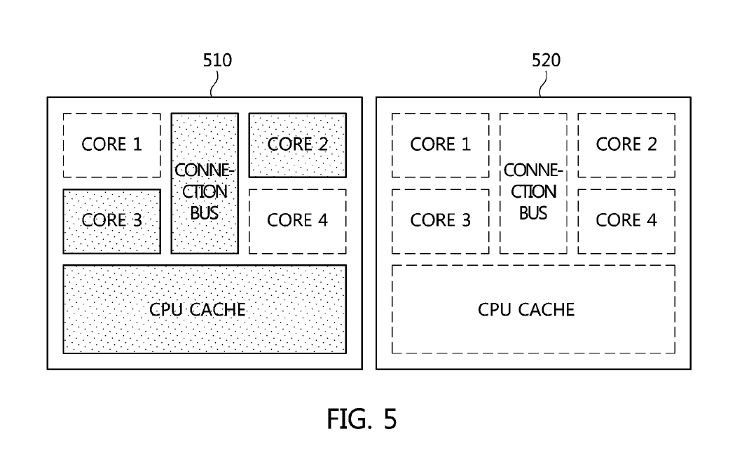

FIG. 5 is a diagram showing the reduction of power consumption based on the level of the idle state of a processor.

Referring to FIG. 5, a state is illustrated in which only the cores 1 and 4 of a CPU 510 have entered low-power mode. The state may be a state in which the remaining components, such as cores, a bus, and a CPU cache, are activated and consume power.

In contrast, it can be seen that a CPU 520 is in a state in which all components have entered low-power mode and the amount of standby power consumption has been considerably reduced compared to the CPU 510.

That is, from the point of view of the C-state, it may be stated that the C-state level and step of the CPU 520 are higher than those of the CPU 510.

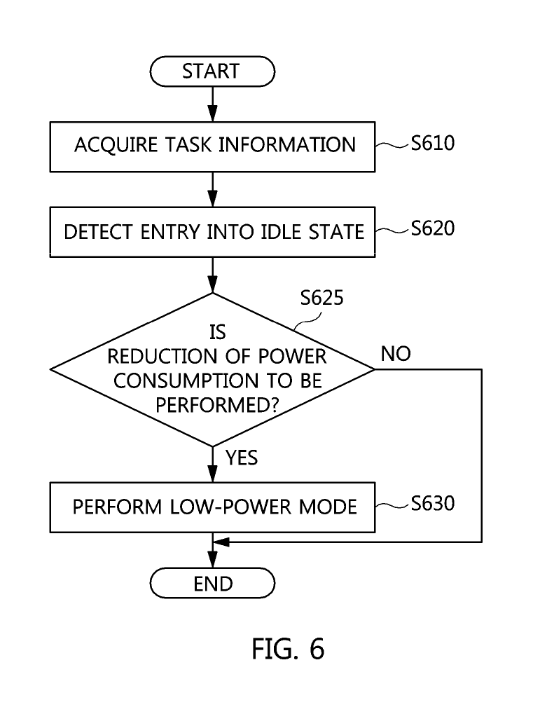

FIG. 6 is an operation flowchart showing a method of reducing the consumption of standby power through the detection of the idle state of a system according to an embodiment of the present invention.

Referring to FIG. 6, the method of reducing the consumption of standby power through the detection of the idle state of a system according to an embodiment of the present invention includes step S610 of acquiring task information from a scheduler that manages the processing of one or more tasks. For example, a list of tasks that need to be currently performed or processed or information about whether a task to be processed remains may be acquired via a CPU scheduler that manages one or more tasks of a CPU.

Furthermore, the method of reducing the consumption of standby power through the detection of the idle state of a system according to an embodiment of the present invention includes step S620 of detecting whether at least one apparatus enters an idle state in which there is no task to be processed based on the task information. For example, a case in which there is no task to be processed for the at least one apparatus may be determined to be an idle state, a separate injector for entry into an idle state may be invoked, and then the idle state may be entered. In this case, the entry into the idle state may be detected by detecting whether the separate injector for entry into the idle state is invoked.

Furthermore, the method of reducing the consumption of standby power through the detection of the idle state of a system according to an embodiment of the present invention includes step S625 of determining whether to perform the reduction of power consumption of at least one apparatus based on at least one of an idle counter and the time elapsed after occurrence.

In this case, the reason for determining whether to perform the reduction of power consumption even when the idle state has been entered is that the size of a load that may occur when the reduction of power consumption is performed may be larger than the size of performance that can be saved due to the reduction of power consumption. Accordingly, in order to prevent a waste from occurring due to the performance of the reduction of power consumption, a case in which the reduction of power consumption can be efficiently performed may be determined using factors, such as an idle counter and the time elapsed after occurrence, and then the reduction of power consumption may be performed.

In this case, the value of the idle counter may be a counter value that is maintained in order to prevent an unnecessary load from occurring due to excessive entry into low-power mode when the number of times the idle state is entered is large.

In this case, the time elapsed after occurrence may correspond to the elapsed time between a current idle state and a previous idle state. For example, it may be possible to check time whenever an idle state occurs and calculate the time elapsed after occurrence via the interval between the checked times.

Furthermore, after the idle state had been entered and then the time elapsed after occurrence has been calculated, current time may be set to previous time in order to prepare for a case in which a subsequent idle state occurs.

In this case, when at least one of a case in which the value of the idle counter exceeds the preset reference entry count and a case in which the time elapsed after occurrence exceeds the preset reference elapsed time occurs, it is determined that the reduction of power consumption is to be performed. For example, when at least one apparatus has entered the idle state, the reduction of power consumption is not performed and the gradually increasing value of the idle counter exceeds the preset reference entry count, the reduction of power consumption may be performed. Furthermore, when the preset reference entry count is not exceeded but the time elapsed after occurrence exceeds the preset reference elapsed time, the reduction of power consumption may be performed.

In this case, in order to determine whether to perform the reduction of power consumption, DeepIdleInjector used for the efficient idle management of the system may be invoked. An action for the actual performance of the reduction of power consumption is performed at DeepIdleInjector, and the apparatus 110 for reducing the consumption of standby power may be implemented in the form of a framework for supporting it. In the case of Linux, the apparatus 110 for reducing the consumption of standby power is designed as a framework called “cpuidle,” and the actual reduction of the consumption of standby power of a CPU is performed in conjunction with its lower-level module. DeepIdleInjector may correspond to the lower-level module.

In this case, when the at least one apparatus enters an idle state, whether to perform the reduction of power consumption is determined. That is, since the reduction of power consumption can be performed only in a state in which there is no task that is processed by the at least one apparatus, whether to perform the reduction of power consumption may be determined only when the idle state has been entered.

In this case, when a system corresponding to the at least one apparatus is activated, the idle counter may be initialized to the preset initial counter value, and the value of the idle counter may be increased based on at least one of a re-entry flag and the time elapsed after occurrence that are used to adjust the number of times the reduction of power consumption is performed. For example, the apparatus 110 for reducing the consumption of standby power may be initialized by invoking the initialization routine of the apparatus 110 for reducing the consumption of standby power from the inside of an OS initialization routine when an OS is booted. In this case, the idle counter and the re-entry flag may be initialized. Furthermore, an initialization invocation point in time may be stored by checking a current point in time and storing the current point in time as previous time point information, and then termination may be performed.

Furthermore, when the time elapsed after occurrence is equal to or shorter than the preset reference elapsed time and also the re-entry flag corresponds to 0, the value of the idle counter may be increased.

In this case, when the system is activated, the re-entry flag may be initialized to the preset initial flag value, the performance of the reduction of power consumption may be released, and then the re-entry flag may be changed.

In this case, the re-entry flag is used to prevent the apparatus 110 for reducing the consumption of standby power from inefficiently operating because the reduction of power consumption is actually frequently performed when DeepIdleInjector is currently frequently invoked. The re-entry flag may correspond to a flag value that is used to determine whether to perform low-power mode.

Furthermore, the re-entry flag may be initialized to a value corresponding to 1 in the initialization routine, and may be changed into a value corresponding to 0 after the reduction of power consumption has been performed.

Furthermore, the time elapsed after occurrence, i.e., the time elapsed from a previous idle state entry point in time (i.e., a previous DeepIdleInjector entry point in time) to a current point in time, may be calculated, and the re-entry flag may be initialized to a value corresponding to 1 if the time elapsed after occurrence is longer than the preset reference elapsed time.

In this case, the preset reference entry count may be determined based on a load that occurs when at least one apparatus enters or returns from the C-state step corresponding to the low-power mode. That is, the occurrence of an unnecessary load due to entry into an excessively low C-state step may be prevented by setting the preset reference entry count in proportion to a stepwise entry and return load of the C-state that is provided by a processor.

Furthermore, the method of reducing the consumption of standby power through the detection of the idle state of a system according to an embodiment of the present invention includes step S630 of, if, as a result of the determination at step S625, it is determined that the reduction of power consumption is to be performed, performing low-power mode for reducing the consumption of standby power of the at least one apparatus using an apparatus manager corresponding to the at least one apparatus if it is determined that the reduction of power consumption is to be performed.

In this case, the low-power mode may be performed using a standby mode support means, supported by the hardware of the system, via the apparatus manager.

For example, the low-power mode may be performed by invoking a routine, such as IdleInjector. IdleInjector is a routine configured to prompt entry into actual low-power mode, and may use the standby mode support means, supported by the hardware, via the apparatus manager. In the case of an X86 system, stepwise C-state entry may be performed by invoking an MWAIT assembly instruction. In the case of an ARM system, entry into the low-power mode may be performed via a Wait For Interrupt (WFI) instruction. When there is no standby mode support means that supported by the hardware, a standby state may be maintained via an instruction, such as NOP/HLT.

Furthermore, at the initialization step of the apparatus 110 for reducing the consumption of standby power, a hardware-level standby mode support means may be automatically searched for, and may be registered and then used in IdleInjector. As an example, in the case of an X86 system, whether an MWAIT instruction is supported may be determined by inspecting a third bit value during the invocation of a CPUID instruction after an ECX register has been set to 1.

Furthermore, if, as a result of the determination at step S625, it is determined that the reduction of power consumption is to be performed, the operation of performing the reduction of the consumption of standby power may be terminated, or a standby may be made to prepare for an idle state that may occur in the future.

Furthermore, although not shown in FIG. 6, the method of reducing the consumption of standby power through the detection of the idle state of a system according to an embodiment of the present invention may include, after the reduction of power consumption has been performed, detecting the occurrence of an event corresponding to the at least one apparatus and releasing the performance of the reduction of power consumption.

In this case, the power reduction release unit 250 may detect the occurrence of an event including at least one of events registered as a non-maskable interrupt, a system management interrupt, an INIT event, a BINT event, an MCERR event, a fault interrupt, an abort interrupt, a machine check interrupt, TLB Invalidation and SoftIRQ.

In this case, a process of searching for and registering a hardware-level standby mode support means is now described. A task in which after entry into the low-power mode, the system is woke up and returns to active mode may be triggered and performed upon the occurrence of a specific event. This event is various according to hardware and system, and may generally correspond to the occurrence of a non-maskable interrupt, the occurrence of a system management interrupt, the occurrence of an INIT event, a BINT event, the occurrence of an MCERR event, the occurrence of a fault interrupt, the occurrence of an abort interrupt, the occurrence of a machine check interrupt, the occurrence of TLB Invalidation, the occurrence of an event registered as SoftIRQ, etc.

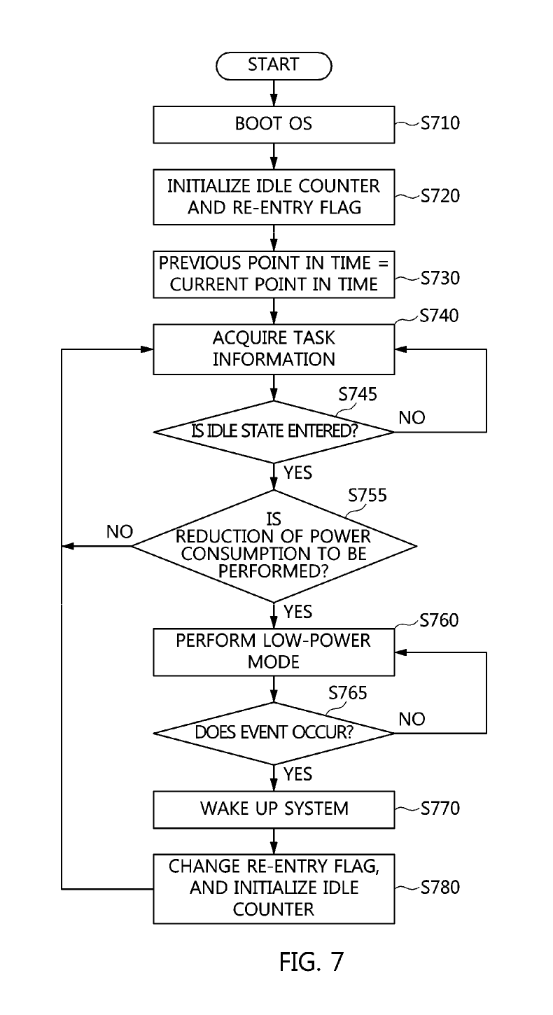

FIG. 7 is an operation flowchart showing a method of reducing the consumption of standby power through the detection of the idle state of a system according to an embodiment of the present invention in detail.

Referring to FIG. 7, the method of reducing the consumption of standby power through the detection of the idle state of a system according to an embodiment of the present invention includes booting an OS at step S710.

Thereafter, an idle counter and a re-entry flag are initialized by initializing the apparatus for reducing the consumption of standby power at step S720. For example, the apparatus for reducing the consumption of standby power may be initialized by invoking the initialization routine of the apparatus 110 for reducing the consumption of standby power from the inside of an OS initialization routine when an OS is booted. In this case, the idle counter may be initialized to 0, and the re-entry flag may be initialized to 1.

Thereafter, a current point in time is stored as previous time point information at step S730. That is, an initialization invocation point in time may be stored.

Thereafter, task information is acquired from a scheduler that manages the processing of one or more tasks at step S740.

Thereafter, whether the at least one apparatus enters an idle state is determines by detecting whether the at least one apparatus enters an idle state in which there is not task to be processed based on the task information at step S745.

If, as a result of the determination at step S745, it is determined that the at least one apparatus enters an idle state, whether to perform the reduction of power consumption of the at least one apparatus is determined based on at least one of an idle counter and the time elapsed after occurrence at step S755.

Furthermore, if, as a result of the determination at step S745, it is determined that the at least one apparatus enters an idle state, task information continues to be acquired, and whether the at least one apparatus enters an idle state is detected.

Furthermore, if, as a result of the determination at step S755, it is determined that the reduction of power consumption is to be performed, low-power mode for reducing the consumption of standby power of the at least one apparatus is performed using an apparatus manager corresponding to the at least one apparatus at step S760.

Furthermore, if, as a result of the determination at step S755, it is determined that the reduction of power consumption is not to be performed, task information continues to be acquired, and whether the at least one apparatus enters an idle state is detected.

Thereafter, it is determines whether an event has occurred in low-power mode at step S765.

In this case, whether an event has occurred in low-power mode may be determined by detecting the occurrence of an event including at least one of events registered as a non-maskable interrupt, a system management interrupt, an INIT event, a BINT event, an MCERR event, a fault interrupt, an abort interrupt, a machine check interrupt, TLB Invalidation and SoftIRQ.

If, as a result of the determination at step S765, it is determined that an event has occurred, a system is woke up and restored at step S770.

In this case, a task in which the system is woke up and returned to active mode after the entry into the low-power mode may be triggered and performed upon the occurrence of a specific event.

If, as a result of the determination at step S765, it is determined that an event has not occurred, the low-power mode continues to be maintained.

Thereafter, after the system has been restored, the value of the re-entry flag is changed to 0 and the idle counter is initialized at step S780. Thereafter, task information is acquired, and entry into an idle state is detected.

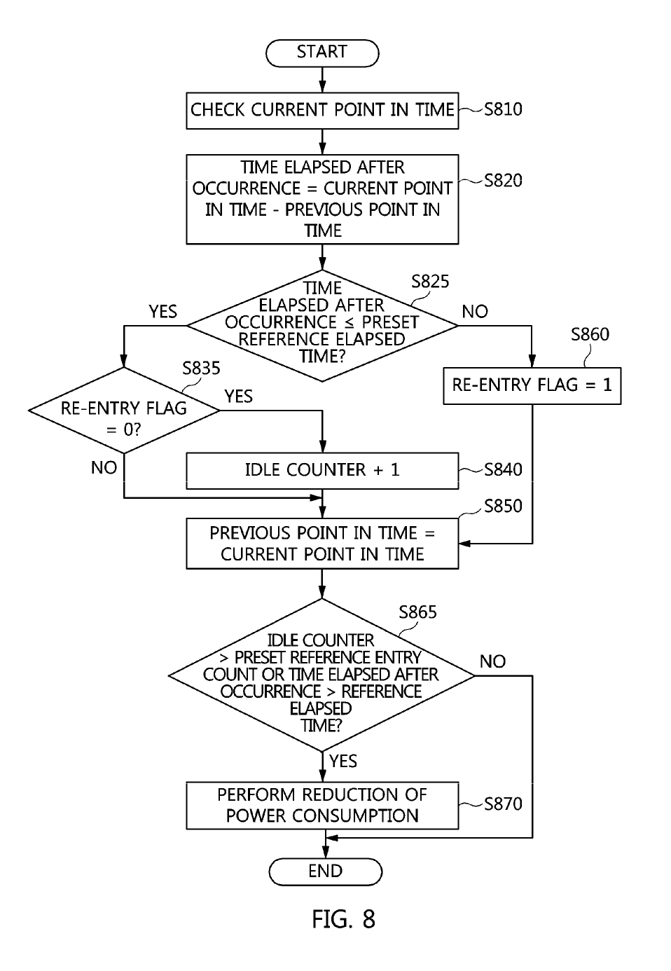

FIG. 8 is an operation flowchart showing the step of determining whether to perform the reduction of power consumption, which is shown in FIG. 7, in detail.

Referring to FIG. 8, the step of determining whether to perform the reduction of power consumption, shown in FIG. 7, includes step S810 of checking a current point in time, and step S820 of calculating the time elapsed after occurrence. That is, the time elapsed after occurrence, corresponding to the time elapsed from the time at which DeepIdleInjector has been previously entered, may be calculated.

Thereafter, it is determined whether the time elapsed after occurrence is equal to or shorter than a preset reference elapsed time at step S825.

If, as a result of the determination at step S825, it is determined that the time elapsed after occurrence is equal to or shorter than the preset reference elapsed time, it is determines whether the re-entry flag corresponds to 0 at step S835.

If, as a result of the determination at step S835, it is determined that the re-entry flag is 0, the value of the idle counter is increased by 1 at step S840, and a current point in time is stored as previous time information at step S850.

Furthermore, if, as a result of the determination at step S825, it is determined that the time elapsed after occurrence is longer than the preset reference elapsed time, the re-entry flag is stored as 1 at step S860, and a current point in time is stored as previous time information at step S850.

In this case, the re-entry flag is a flag value for performing low power mode efficiently when DeepIdleInjector is currently frequently invoked. The re-entry flag may be initialized to 1 in an initialization routine. Further, the value of the idle counter may be a counter value that is maintained in order to prevent an unnecessary load from occurring due to excessive entry into low-power mode when the number of times DeepIdleInjector is entered is large. The idle counter may be initialized to 0 whenever returning from the low-power mode.

Thereafter, it is determines whether the value of the idle counter exceeds a preset reference entry count or the time elapsed after occurrence exceeds preset reference elapsed time at step S865.

If, as a result of the determination at step S865, it is determined that the value of the idle counter exceeds the preset reference entry count or the time elapsed after occurrence exceeds the preset reference elapsed time, it is determined that the reduction of power consumption is to be performed at step S870.

If, as a result of the determination at step S865, it is determined that the value of the idle counter does not exceed the preset reference entry count or the time elapsed after occurrence does not exceed the preset reference elapsed time, it is determined that the reduction of power consumption is not to be performed, and then termination is performed.

According to at least one embodiment of the present invention, there is provided a method of reducing the consumption of standby power that prevents unnecessary entry into low-power mode, thereby minimizing disadvantages regarding power and performance.

At least one embodiment of the present invention efficiently performs the reduction of the consumption of standby power based on elapsed time in an idle state, thereby improving the effect of reducing the consumption of standby power.

The apparatus and method apparatus for reducing the consumption of standby power through the detection of the idle state of a system according to an embodiment of the present invention are not limited to the configurations and methods of the above-described embodiments, but some or all of the embodiments may be configured to be selectively combined such that the embodiments can be modified in various manners.

What is claimed is:

1. An apparatus for reducing consumption of standby power through detection of an idle state of a system, comprising:
a task information acquisition unit configured to acquire task information from a scheduler that manages processing of one or more tasks;
an idle state detection unit configured to detect whether at least one apparatus enters an idle state, in which there is no task to be processed, based on the task information;
a power reduction determination unit configured to determine whether to perform reduction of power consumption of the at least one apparatus based on at least one of an idle counter and time elapsed after occurrence; and
a power reduction performance unit configured to perform low-power mode for reducing consumption of standby power of the at least one apparatus using an apparatus manager corresponding to the at least one apparatus if it is determined that the reduction of power consumption is to be performed.

2. The apparatus of claim 1, wherein the power reduction determination unit determines that the reduction of power consumption is to be performed if at least one of a case in which a value of the idle counter exceeds a preset reference entry count and a case in which the time elapsed after occurrence exceeds preset reference elapsed time occurs.

3. The apparatus of claim 2, wherein the power reduction determination unit determines whether to perform the reduction of power consumption if the at least one apparatus enters the idle state.

4. The apparatus of claim 3, wherein the power reduction determination unit comprises:
an idle counter management unit configured to, when a system corresponding to the at least one apparatus is activated, initialize the idle counter to a preset initial counter value, and increase the value of the idle counter based on at least one of a re-entry flag and the time elapsed after occurrence that are used to adjust a number of times the reduction of power consumption is performed; and
a re-entry flag management unit configured to, when the system is activated, initialize the re-entry flag to a preset initial flag value, release the reduction of power consumption, and change the re-entry flag.

5. The apparatus of claim 1, further comprising a power reduction release unit configured to, after the reduction of power consumption has been performed, detect an occurrence of an event corresponding to the at least one apparatus, and release the performance of the reduction of power consumption.

6. The apparatus of claim 5, wherein the power reduction determination unit determines the preset reference entry count while taking into account a load that occurs when the at least one apparatus enters and returns from a C-state step corresponding to the low-power mode.

7. The apparatus of claim 6, wherein the power reduction performance unit performs the low-power mode using a standby mode support means, supported by hardware of the system, via the apparatus manager.

8. The apparatus of claim 5, wherein the power reduction release unit detects an occurrence of an event including at least one of events registered as a non-maskable interrupt, a system management interrupt, an INIT event, a BINT event, an MCERR event, a fault interrupt, an abort interrupt, a machine check interrupt, TLB Invalidation, and SoftIRQ.

9. The apparatus of claim 1, wherein the time elapsed after occurrence corresponds to elapsed time between a current idle state and a previous idle state.

10. A method of reducing consumption of standby power through detection of an idle state of a system, comprising:
acquiring task information from a scheduler that manages processing of one or more tasks;
detecting whether at least one apparatus enters an idle state, in which there is no task to be processed, based on the task information;
determining whether to perform reduction of power consumption of the at least one apparatus based on at least one of an idle counter and time elapsed after occurrence; and
performing low-power mode for reducing consumption of standby power of the at least one apparatus using an apparatus manager corresponding to the at least one apparatus if it is determined that the reduction of power consumption is to be performed.

11. The method of claim 10, wherein the determining comprises determining that the reduction of power consumption is to be performed if at least one of a case in which a value of the idle counter exceeds a preset reference entry count and a case in which the time elapsed after occurrence exceeds preset reference elapsed time occurs.

12. The method of claim 11, wherein the determining comprises determining whether to perform the reduction of power consumption if the at least one apparatus enters the idle state.

13. The method of claim 12, wherein the determining comprises:
initializing the idle counter to a preset initial counter value when a system corresponding to the at least one apparatus is activated;
increasing the value of the idle counter based on at least one of a re-entry flag and the time elapsed after occurrence that are used to adjust a number of times the reduction of power consumption is performed;
initializing the re-entry flag to a preset initial flag value when the system is activated; and
releasing the reduction of power consumption, and then changing the re-entry flag.

14. The method of claim 10, further comprising, after the reduction of power consumption has been performed, detecting an occurrence of an event corresponding to the at least one apparatus, and releasing the performance of the reduction of power consumption.

15. The method of claim 14, wherein the determining comprises determining the preset reference entry count while taking into account a load that occurs when the at least one apparatus enters and returns from a C-state step corresponding to the low-power mode.

16. The method of claim 15, wherein the performing comprises performing the low-power mode using a standby mode support means, supported by hardware of the system, via the apparatus manager.

17. The method of claim 14, wherein the releasing comprises detecting an occurrence of an event including at least one of events registered as a non-maskable interrupt, a system management interrupt, an INIT event, a BINT event, an MCERR event, a fault interrupt, an abort interrupt, a machine check interrupt, TLB Invalidation, and SoftIRQ.

18. The method of claim 10, wherein the time elapsed after occurrence corresponds to elapsed time between a current idle state and a previous idle state.
